(19) United States
(12) Patent Application Publication
(10) Pub. No.: US 2016/0238126 A1
(43) Pub. Date: Aug. 18, 2016

(54) PLANET CARRIER FOR AN EPICYCLIC SPEED REDUCTION GEAR

(71) Applicant: HISPANO-SUIZA, Colombes (FR)

(72) Inventors: Guillaume Beck, Chantilly (FR); Boris Morelli, Paris (FR); Jordane Peltier, Paris (FR)

(73) Assignee: Hispano-Suiza, Colombes (FR)

(21) Appl. No.: 15/027,475

(22) PCT Filed: Oct. 9, 2014
(86) PCT No.: PCT/FR2014/052553

§ 371 Date: Apr. 6, 2016

(30) Foreign Application Priority Data
Oct. 10, 2013 (FR) 1359845

(51) Int. Cl. F16H 57/08

(52) U.S. Cl. CPC F16H 57/082; F05D 2260/40311

(57) ABSTRACT

The invention concerns a planet carrier (5) for an epicyclic speed reduction gear, comprising an annular cage (7) comprising two sides (9, 10) extending radially, linked by bridges (16), seats (6) extending axially between the sides (9, 10) and being intended to support planet gears mounted rotating about the seats (6). One (9) of the sides (9, 10) of the cage (7) is immovably fixed to a torque output member (8), in such a way as to form a single structural assembly.

The present invention relates to an epicyclic speed reduction gear, intended to equip in particular a turboprop or an airplane turbine engine.

A speed reduction gear mainly consists of an inner planet gear (also called a sun gear) driven by an input shaft, for example a turbine shaft, an outer planet gear (also called a crown gear), coaxial with the inner gear, with planets meshing with both the inner and the outer planet gears, and a planet carrier whereon the planets are mounted to rotate.

The variation of the reduction ratio of such a speed reduction gear is obtained by changing the number of teeth of the inner planet gear, of the planets and of the outer planet gear, and the architecture of the speed reduction gear. In fact two types of speed reduction gears exist:
the planetary reduction gear wherein the planet carrier is stationary and the outer gear or crown gear is free to rotate. The optimized operating range of this type of reduction gear corresponds to a reduction ratio ranging from 1 to 3,
the epicyclic speed reduction gear wherein the crown gear is stationary and the planet gear is free to rotate. The optimized operating range of this type of reduction gear corresponds to a reduction ratio above 3.

The invention more particularly relates to the field of epicyclic speed reduction gears.

In this particular case, it is important that the planet carrier makes it possible to maintain the correct positioning of planets, in spite of the deformations experienced by the planet carrier when operating.

As a matter of fact, when the transmitted torque is important, this can cause the planet carrier to twist and, consequently, the planet axis to be misaligned. Besides, the planets can be subjected to high centrifugal forces, which may again generate a misalignment of planets.

Such misalignments may more particularly cause premature wearing of such gears and of the speed reduction gear.

To partially address this problem, the document U.S. Pat. No. 5,391,125 provides for an epicyclic speed reduction gear wherein the planet carrier comprises an annular cage comprising two radially extending sides linked by bridges, with seats extending axially between the sides and being intended to support planets mounted rotating about the seats. The planet carrier further comprises a torque output member, one end of which is equipped with axial arms fastened to the various bridges of the cage by means of pins.

Patent application FR 2 853 382 in the name of the Applicant, discloses a speed reduction gear having a similar architecture, wherein the arms of the torque output member are linked to the bridges through finger-type spherical joints, so as to locally allow the free rotation of the cage relative to the finger, about the spherical joint and further reduce the deformation of the planet carrier in operation.

This type of speed reduction gear has the following disadvantages.

First, the dimensioning of the planet carriers is complex for reduction gears designed to transmit very high torques, since areas with high stress concentration exist.

In addition, the fact that the planet carrier consists of two elements (a cage and a torque output member) assembled together by linking elements such as pins, generates a large mass, which entails specific mounting problems as well as problems resulting from the system hyperelasticity.

Finally, the presence of additional linking elements between the cage and the torque output member affects the reliability of the system.

Such disadvantages are also present in the planet carrier mentioned in document US 2003/0114267, which consists of many parts assembled together through pads assembled with the press.

It is also known to equip the planet carrier with a speed reduction gear with so-called swiveling bearings, such as, for example spherical roller bearings, so as to compensate, to a certain extent, for any deformation of the planet carrier.

Such bearings, however, cannot be heavily loaded.

As a matter of fact, such bearings have a lower load capacity than the usually employed technologies (supported load relative to the roller volume). Therefore, using these requires a general increase in the volume of the entire epicyclic speed reduction gear, which is penalizing in terms of size and mass.

Documents US 2013/0017924, EP 0271416 and DE 102 39 084 each disclose a planet carrier having an annular cage comprising a first side and a second side extending radially, linked by bridges, seats for supporting planets axially extending between the sides. In these documents, as the torque output is formed on the inner periphery of the first side, a first load path goes through the first side, from a first end of the seats up to the inner periphery of the first side. A second load path goes through a portion of the second side (from the second ends of the seats up to the linking regions between the second side and the bridges), the bridges and then the first side (from the linking regions between the bridges and the first side up to the radially inner periphery of the first side). It can thus be noted that the first load path has a stiffness which depends on the stiffness of the first side, whereas the second load path has a stiffness which depends on the stiffness of the first side, the second side and the bridges. As the stiffness of both load paths is substantially different, a misalignment of the seats occurs, which affects the control of the positions of the planets and thus the wear of the associated gears.

The invention more particularly aims at providing a simple, efficient and cost-effective solution to these problems.

To this end, it provides for a planet carrier for an epicyclic speed reduction gear having an annular cage comprising two sides extending radially, linked by bridges, seats extending axially between the sides and being intended to support planets mounted rotating about the seats, characterized in that one of the sides of the cage is irremovably linked to a torque output member, so as to form a single structural assembly.

The non-removable connection between the cage and the torque output member prevents any mounting problem.

According to one embodiment of the invention, the torque output member and the matching side of the cage are constructed as a single piece.

According to another embodiment of the invention, the torque output member and the side consist of at least two distinct parts assembled together by welding or brazing.

Of course, other assembly methods may be used.

In either case, the presence of additional elements, and therefore the mounting, weight and space constraints which are associated with such additional elements are avoided.

Preferably, the bridges extend axially from the radially outer peripheries of the side.

In this case, the torque output member is linked to the matching side, along an annular zone located on the radially outer periphery of said side only.

A first load path thus goes through a first side (i.e. the side directly linked to the torque output member), from the matching ends of the seats of the planets up to the linking zone between the first side and the torque output member and then the output member. A second load path goes through the second side of the cage (from the matching ends of the seats of the planets up to the linking zones between the second side and the bridges), the bridges and then the torque output member. The stiffness of each of the two load paths can thus be adjusted to control the deformations resulting from the transmission of a high torque and the misalignments of the seats. This allows a better control of the planet gear positions and thus wear of the gears in the speed reduction gear. In this case too, the load paths are separate.

The linking zone being annular, preferably continuous, avoids the effects of stress concentration and aims at uniformly distributing the deformations, if any, resulting from the transmission of a high torque in operation. This also helps to increase the rigidity of the link between the cage and the torque output member.

The torque output member may comprise an axially extending tubular portion, one end of which is extended by an annular linking portion which extends radially and is linked to the matching side of the cage.

Said annular linking portion is preferably located radially outside the seat, more particularly opposite the bridges.

In this case, the linking portion may include an axially extending annular rim, the free end of which is linked to the matching side.

Preferably, the bridges and the sides are one solid piece.

In addition, both sides may have substantially the same radial stiffness.

Under the effect of centrifugal forces, the two sides are thus deformed in the same way, which allows to maintain a proper alignment at the seats of the planets, and therefore a correct positioning of the planets.

The invention further relates to an epicyclic speed reduction gear, in particular for an aircraft turbine engine, comprising a planet carrier of the above-mentioned type.

The invention will be better understood, and other details, characteristics and advantages of the invention will appear upon reading the following description given by way of a non-restrictive example while referring to the appended drawings wherein:

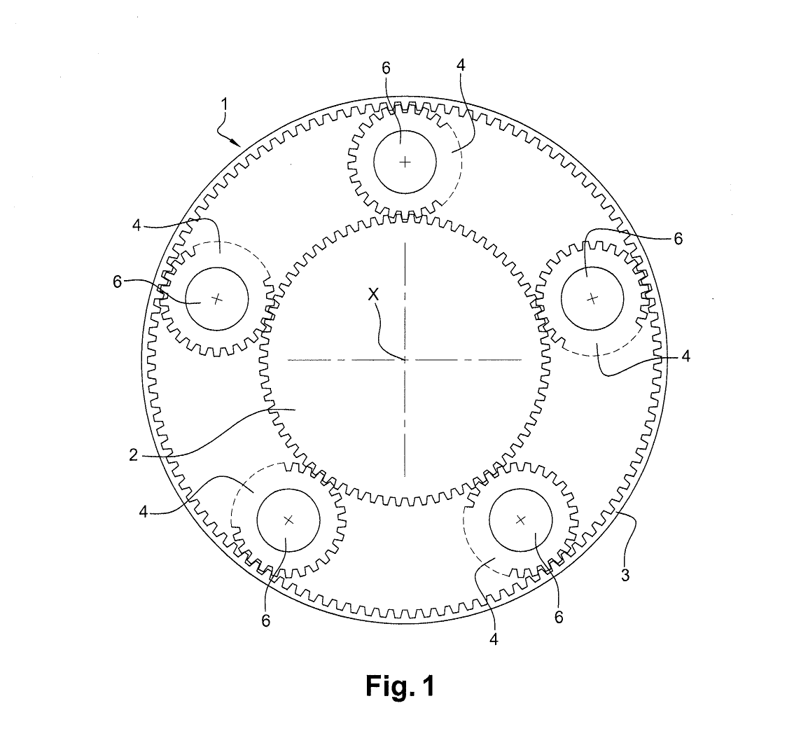

FIG. 1 is a schematic front view of an epicyclic speed reduction gear,

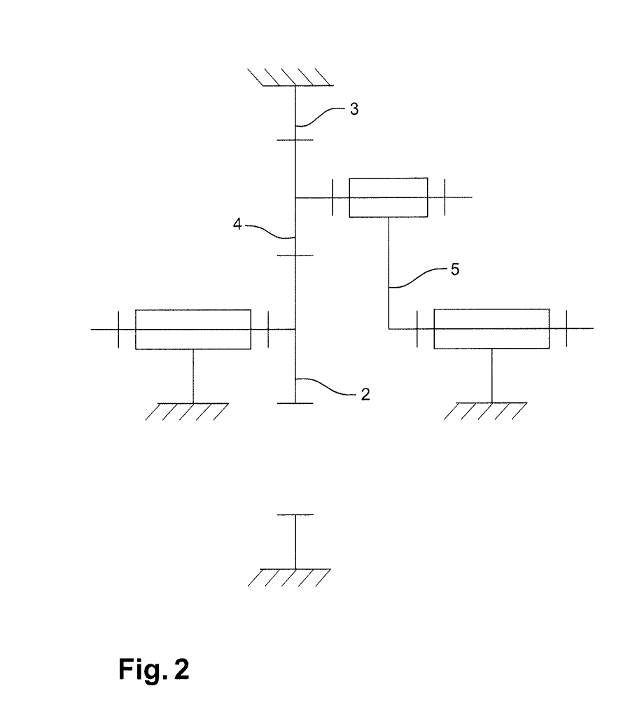

FIG. 2 is a kinematic diagram of an epicyclic speed reduction gear,

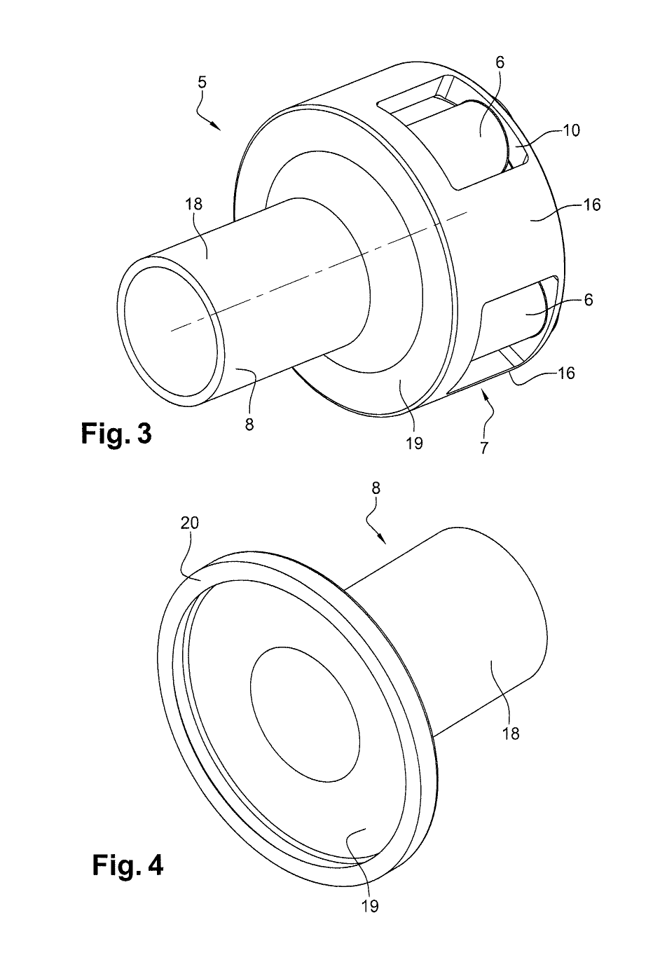

FIG. 3 is a schematic view of a planet carrier according to the invention,

FIG. 4 is a perspective view of the torque output member and of the planet carrier of FIG. 3,

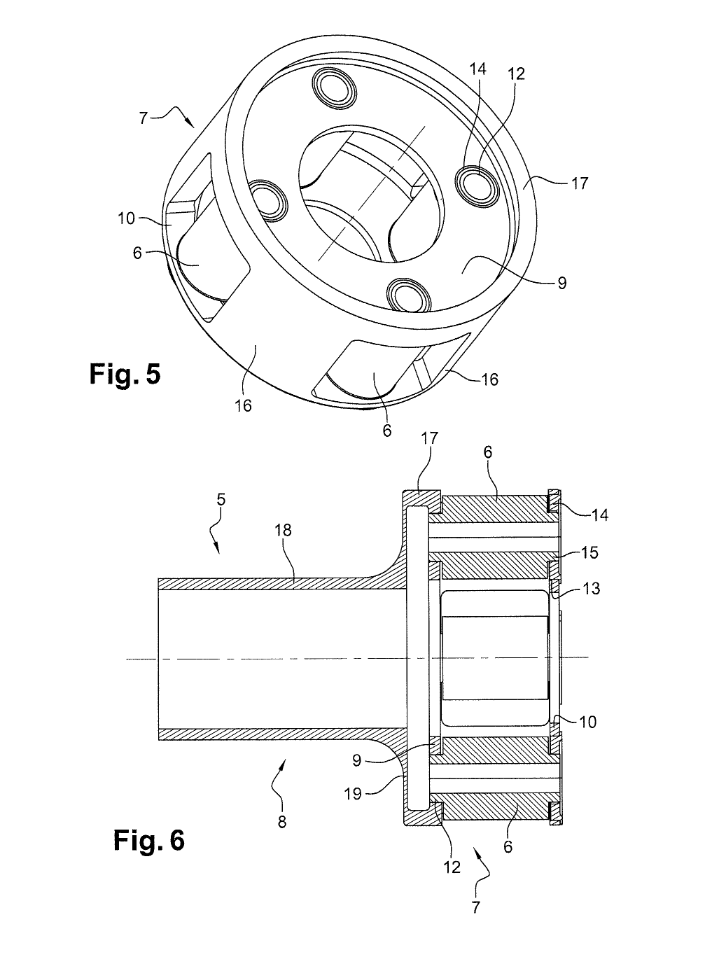

FIG. 5 is a perspective view of the cage of the planet carrier of FIG. 3,

FIG. 6 is an axial cross-sectional view of the planet carrier of FIG. 3;

FIGS. 1 and 2 illustrate the general structure of an epicyclic speed reduction gear 1. Such a speed reduction gear conventionally consists of an inner planet gear 2 (also called a sun gear) driven by an input shaft, for example a turbine shaft, an outer planet gear 3 (also called a crown gear), coaxial with the inner gear, with planets 4 meshing with both the inner 2 and the outer 3 planet gears, and a planet carrier 5 comprising seats 6 about which the planets 4 are mounted to rotate.

As shown in FIG. 2, in an epicyclic speed reduction gear 1, the crown 3 is stationary and the planet carrier 5 is free to rotate. The optimized operating range of this type of reduction gear corresponds to a reduction ratio above 3. The planet carrier 5 is for example coupled in rotation to an impeller (in the case of a turboprop) or a fan wheel (in the case of a turbine engine).

In this particular case, it is important for the planet carrier 5 to enable the correct positioning of planets to be maintained, in spite of the deformations experienced by the planet carrier when operating.

As a matter of fact, when the torque transmitted through the gear 1 is important, this may cause the planet carrier to twist and, consequently, the planet axis to be misaligned. Besides, the planets may also be generate a deformation of the planet carrier 5, which may then again generate a misalignment of the planets 4.

Such misalignments may more particularly cause premature wearing of gears and of the speed reduction gear 1.

The invention provides for a planet carrier 5 for an epicyclic speed reduction gear to remedy this problem.

As shown in FIGS. 3 to 6, the planet carrier 5 of the invention comprises an annular cage 7 and a torque output member 8.

The annular cage 7 has two radially extending sides 9, 10, respectively a front side 9 and a rear side 10. Each side 9, 10 has a circular outer peripheral edge and an inner peripheral edge. The front side 9 is provided with holes, each one being used for mounting one end 12 of a hollow shaft forming a seat 6 about which a planet gear 4 is intended to be mounted rotating. The rear side 10 has openings 13 each enabling the insertion of the matching shaft, from the rear to the front. A lid 14 closes each opening 13, with the second end 15 of the matching shaft 6 being mounted in one opening of said lid 14.

Each shaft 6 is thus fixedly held between the two sides 9, 10 of the cage 7. In the embodiment illustrated in FIGS. 3 to 6, the planet carrier 5 comprises five hollow shafts 6 fixed to the sides 9, 10 and to the covers 14.

The radially outer peripheries of the sides 9, 10 are linked by axially extending bridges 16 circumferentially inserted between the hollow shafts 6 and regularly distributed over the circumference.

The sides 9, 10 and the bridges 16 are made of one piece, i.e. of a solid piece.

The radially outer periphery of the front side 9 has an annular rim 17 (FIG. 5) which continuously extends over the entire circumference of the front side 9 and axially extends away from the rear side.

The torque output member 8 is fixed to the cage 7. More particularly, the torque output member 8 has a generally cylindrical or frustoconical hollow portion 18 which extends axially, one end of which is extended by an annular linking portion 19 which radially extends outwardly.

The radially outer portion of the linking portion 19 has an annular rim 20 (FIG. 4) which continuously extends over the entire circumference of the linking portion 19 and which axially extends towards the front side 9.

According to one embodiment of the invention, the free end of the rim 20 of the linking portion 19 is fixed by welding or brazing to the free end of the rim 17 of the front side 9. Other assembling methods can be used.

According to another embodiment (FIG. 6), the cage 7 and the torque output member 8 are formed of a single piece.

As indicated above, in operation, a first load path goes through the front side 9 (from the matching ends 12 of the seats 6 of the planet gears 4 up to the rim 17) and then the output member 8. A second load path goes through the rear side 10 (from the matching ends 15 of the seats 6 of the planet gears 4 up to the linking areas between the rear side 10 and the bridges 16), the bridges 16 and finally the torque output member 8.

Preferably, the two sides 9, 10 have substantially the same radial stiffness. Thus, in operation, the two sides 9, 10 undergo the same deformations under the effect of centrifugal forces.

The bridges 16 are also intended to give them a significant torsional stiffness. Thus, the deformations undergone by the components affected by the first and second load paths respectively are substantially identical.

In practice, the second load path has a slightly smaller torsional rigidity than the first load path (the stiffness of the bridges 16 is not infinite), with such difference in stiffness being easily compensated by a proper correction of the teeth of planets 4 and/or of the inner and outer planets 2, 3.

This ensures that the front and rear sides 9, 10 globally deform the same way in operation, due to the effect of centrifugal forces as well as a result of a high torque to be transmitted. This maintains a proper alignment of the ends 12, 15 of the shafts 6, i.e. a proper alignment of the planets 4 with respect to the inner planet gear 2 and to the outer planet gear 3 of the epicyclic speed reduction gear 1. Wearing of gears in such a speed reduction gear 1 is then substantially reduced.

The fact that the linking region between the output member 8 and the front side 9 is annular, preferably continuous, makes it possible to prevent the effects of stress concentration and aims at uniformly distributing any distortion due to the transmission of a high torque in operation. Such linking also has a high rigidity.

Eventually, the planet carrier 5 forms a single structural assembly, which eliminates the problems relating to the assembling of several pieces by means of additional linking members, namely, the reliability and the dimensioning of the linking members, the unbalance generated by the assembly tolerances, mounting problems due to the static indeterminacy of the parts, or the additional mass resulting from the high number of parts.

1. A planet carrier for an epicyclic speed reduction gear, comprising an annular cage comprising two sides extending radially and linked by bridges, seats extending axially between the sides and being intended to support planet gears mounted rotating about the seats, wherein one of the sides of the cage is irremovably fixed to a torque output member in such a way as to form a single structural assembly, and in that the torque output member comprises an axially extending tubular portion, one end of which is extended by an annular linking portion extending radially and linked to the matching side of the cage, for example by welding or brazing.

2. A planet carrier according to claim 1, wherein said annular linking portion is located radially outside the seats, preferably opposite the bridges.

3. A planet carrier according to claim 1, wherein the annular linking portion of the torque output member and the side are assembled together by welding or brazing.

4. A planet carrier according to claim 1, wherein the bridges extend axially from the radially outer peripheries of the sides.

5. A planet carrier according to claim 4, wherein the torque output member is linked to the matching side along an annular zone located on the radially outer periphery of said side only.

6. A planet carrier according to claim 1, wherein the linking portion has an axially extending annular rim, the free end of which is linked to the matching side.

7. A planet carrier according to claim 1, wherein the bridges and the sides are made of one piece.

8. A planet carrier according to claim 1, wherein both sides have substantially the same radial stiffness.

9. A planet carrier according to claim 1, wherein the torsional stiffness of the sides of the cage is substantially identical.

10. A planet carrier for an epicyclic speed reducer, more particularly for an aircraft turbine engine, comprising a planet carrier according to claim 1.
